(19) United States
(12) Patent Application Publication
(10) Pub. No.: US 2023/0147839 A1
(43) Pub. Date: May 11, 2023

(54) DATA TRANSMISSION METHOD AND APPARATUS, COMMUNICATION DEVICE, AND STORAGE MEDIUM

(71) Applicant: Beijing Xiaomi Mobile Software Co., Ltd., Beijing (CN)

(72) Inventor: Xiandong DONG, Beijing (CN)

(21) Appl. No.: 17/912,192

(22) PCT Filed: Mar. 18, 2020
(86) PCT No.: PCT/CN2020/080071

§ 371 Date: Sep. 16, 2022

(51) Int. Cl. H04L 1/1607

(52) U.S. Cl. CPC H04L 1/1607

(57) ABSTRACT

A data transmission method includes: determining duration indication information according to the reception status of a data frame in a multi-transmission connection transmission, the duration indication information being used to indicate the duration for which a transmission connection is continuously occupied; and sending a first confirmation message frame, the first confirmation message frame including feedback information of the reception status and the duration indication information.

### CROSS REFERENCE TO RELATED APPLICATIONS

The present disclosure is a U.S. national phase application of International Application No. PCT/CN2020/080071 filed on Mar. 18, 2020, which is incorporated herein by reference in its entirety.

### TECHNICAL FIELD

The present application relates to but is not limited to the field of wireless communication technology, and in particular, to a data transmission method, an apparatus, a communication device, and a storage medium.

### BACKGROUND

A new generation of mainstream Wi-Fi technology is mainly characterized in the use of a wide bandwidth up to 320 MHz, and the use of aggregation and coordination technology for multiple frequency bands, etc. Compared with existing IEEE802.11ax, the rate and throughput are increased by at least four times. A main application scenario of the new technology is video transmission, augmented reality (AR), and virtual reality (VR), etc. In such scenarios, the aggregation and coordination technology for multiple frequency bands refers to simultaneous communication between Wi-Fi devices in frequency bands of 2.4 GHz, 5.8 GHz and 6-7 GHz.

### SUMMARY

Embodiments of the present disclosure provide a data transmission method, an apparatus, a communication device, and a storage medium.

According to one aspect of embodiments of the present disclosure, there is provided a data transmission method, applied to a first communication device, which includes: determining duration indication information according to reception of a data frame in multi-transport connection transmission, wherein the duration indication information is used to indicate duration of a transport connection continuing to be occupied; and sending a first acknowledgement message frame, wherein the first acknowledgement message frame includes feedback information about the reception and the duration indication information.

According to another aspect of embodiments of the present disclosure, there is provided a data transmission method, applied to a second communication device, which includes: receiving a first acknowledgement message frame; determining reception of a data frame in multi-transport connection transmission according to feedback information in the first acknowledgment message frame; and determining duration of a transport connection continuing to be occupied according to duration indication information in the first acknowledgment message frame, wherein the duration indication information is based on the reception of the data frame.

According to another aspect of embodiments of the present disclosure, there is provided a data transmission method, applied to a third communication device, which includes: receiving a first acknowledgement message frame; and setting a Network Allocation Vector (NAV) according to duration of a transport connection continuing to be occupied indicated by duration indication information in the first acknowledgment message frame, wherein the duration indication information is based on reception of a data frame in multi-transport connection transmission.

According to another aspect of embodiments of the present disclosure, there is provided a data transmission apparatus, applied to a first communication device, which includes a first determination module and a sending module, wherein the first determination module is configured to determine duration indication information according to reception of a data frame in multi-transport connection transmission, wherein the duration indication information is used to indicate duration of a transport connection continuing to be occupied; and the sending module is configured to send a first acknowledgement message frame, wherein the first acknowledgement message frame includes feedback information about the reception and the duration indication information.

According to another aspect of embodiments of the present disclosure, there is provided a data transmission apparatus, applied to a second communication device, which includes a first receiving module, a second determination module, and a third determination module, wherein the first receiving module is configured to receive a first acknowledgement message frame; the second determination module is configured to determine reception of a data frame in multi-transport connection transmission according to feedback information in the first acknowledgment message frame; and the third determination module is configured to determine duration of a transport connection continuing to be occupied according to duration indication information in the first acknowledgment message frame, wherein the duration indication information is based on the reception of the data frame.

According to another aspect of embodiments of the present disclosure, there is provided a data transmission apparatus, applied to a third communication device, which includes a second receiving module and a setting module, wherein the second receiving module is configured to receive a first acknowledgement message frame; and the setting module is configured to set a Network Allocation Vector (NAV) according to duration of a transport connection continuing to be occupied indicated by duration indication information in the first acknowledgment message frame, wherein the duration indication information is based on reception of a data frame in multi-transport connection transmission.

According to another aspect of embodiments of the present disclosure, there is provided a data transmission apparatus, including a processor, a memory, and an executable program stored on the memory and capable of being executed by the processor, wherein the data transmission method described in above aspects is implemented when the executable program is executed by the processor.

According to another aspect of embodiments of the present disclosure, there is provided a storage medium having an executable program stored thereon, wherein the data transmission method described in above aspects is implemented when the executable program is executed by a processor.

According to the data transmission method, the apparatus, the communication device, and the storage medium provided by embodiments of the present disclosure, a data frame receiver determines the duration indication information according to the reception of a data frame in multi-transport connection transmission. The duration indication information is used to indicate duration of the transport connection continuing to be occupied. The data frame receiver sends a first acknowledgement message frame, and the first acknowledgement message frame includes feedback information about the reception and the duration indication information. In this way, the duration of the transport connection continuing to be occupied indicated by the first acknowledgment message frame can be determined according to the reception of the data frame. In one aspect, the duration is no longer fixed as the same one, so as to improve the flexibility of setting of the duration. In another aspect, the duration can be set as relatively fixed duration according to subsequent transmission requirements, so as to reduce the waste of resources caused by occupying the transport connection when there is no transmission demand, and also to reduce the transmission delay caused by re-contention for the transport connection due to insufficient duration, thereby improving the transmission efficiency.

It should be understood that the foregoing general description and the following detailed description are exemplary only and do not limit the present disclosure.

### BRIEF DESCRIPTION OF THE DRAWINGS

The drawings, which are incorporated in and constitute a part of this specification, illustrate embodiments consistent with the present disclosure and serve together with the specification to explain the principles of embodiments of the present disclosure.

FIG. 1 is a schematic flowchart of a data transmission method according to an exemplary embodiment;

FIG. 2 is a schematic flowchart of another data transmission method according to an exemplary embodiment;

FIG. 3 is a schematic flowchart of another data transmission method according to an exemplary embodiment;

FIG. 4 is a block diagram of a data transmission apparatus according to an exemplary embodiment;

FIG. 5 is a block diagram of another data transmission apparatus according to an exemplary embodiment;

FIG. 6 is a block diagram of another data transmission apparatus according to an exemplary embodiment; and

FIG. 7 is a block diagram of an apparatus for data transmission according to an exemplary embodiment.

### DETAILED DESCRIPTION

Exemplary embodiments will be described in detail herein, examples of which are illustrated in the drawings. When the following description refers to the drawings, the same numerals in different drawings indicate the same or similar elements unless otherwise indicated. Implementations described in following exemplary embodiments do not represent all implementations consistent with embodiments of the present disclosure. Rather, they are merely examples of apparatus and methods consistent with some aspects of embodiments of the present disclosure as recited in the appended claims.

Terms used in embodiments of the present disclosure are only for the purpose of describing particular embodiments, and are not intended to limit embodiments of the present disclosure. As used in embodiments of the present disclosure and the appended claims, singular forms “a”. “said” and “the” are intended to include plural forms as well, unless the context clearly dictates otherwise. Also, it should be understood that a term “and/or” as used herein refers to including any or all possible combinations of one or more associated items listed.

It should be understood that a term “include” as used herein means consisting at least in part of recited items. For example, “include A, B. C” may mean that only items A. B, and C are included, or at least A. B. and C may be included, and other items may also be included. In addition, without departing from the spirit of the technical solutions of the present disclosure, those skilled in the art should understand that the term “include” may also mean “depend on” or “based on”. For example, “A includes B” may mean “A is based on B”, or “A depends on B”.

It should be understood that although terms first, second, third, etc., may be used in embodiments of the present disclosure to describe various information, such information should not be limited to these terms. These terms are only used to distinguish the same type of information from each other. For example, without departing from the scope of embodiments of the present disclosure, the first information may also be referred to as the second information, and similarly, the second information may also be referred to as the first information, depending on the context. For example, a word “if” used herein can be interpreted as “at the time when” or “when” or “in response to determining”.

An execution subject involved in embodiments of the present disclosure includes but is not limited to a network device in a wireless communication network, especially in a Wi-Fi network (such as under the IEEE802.11a/b/g/n/ac standard), and a network device in a next-generation Wi-Fi network (such as under the IEEE802.11be standard). The network device includes but is not limited to a wireless access point (AP) device such as a Wi-Fi router, a wireless station (STA), a user terminal, a user node, a mobile terminal or a tablet computer, etc.

An application scenario of embodiments of the present disclosure is as follows. Under the existing IEEE802. II standards, after the transmission of a data frame is completed, a data frame receiver feeds back an acknowledgment (ACK) message frame to a data frame sender. The acknowledgment message frame can be divided into two types, namely an ACK frame for a unicast data frame, and a block ACK (BA) frame for a continuous data frame. Regardless of whether or not the data frame is successfully received, both durations indicated by a duration field in the two acknowledgement message frames do not contain duration required for retransmission of a data frame. If the data frame sender needs to retransmit the data frame, it needs to re-occupy a communication connection by means of contention or the like, thus increasing a transmission delay of the data frame and reducing the transmission efficiency.

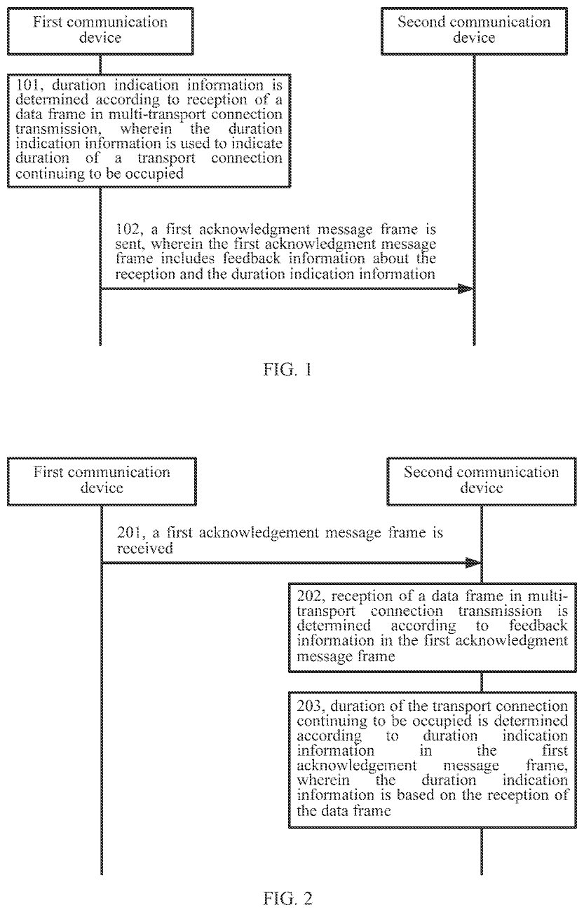

As shown in FIG. 1, exemplary embodiments provide a data transmission method. The data transmission method may be applied to a first communication device for wireless communication. The data transmission method may include following steps.

In a step 101, duration indication information is determined according to reception of a data frame in multi-transport connection transmission. The duration indication information is used to indicate duration of a transport connection continuing to be occupied.

In a step 102, a first acknowledgment message frame is sent. The first acknowledgment message frame includes feedback information about the reception and the duration indication information.

The wireless communication here may be Wi-Fi communication using a standard such as IEEE802.11be. A first communication device, a second communication device and a third communication device may be wireless stations (STAs) or wireless access points (APs), etc., in the Wi-Fi communication. The data frame may be a data frame that is separately transmitted in each of multiple transport connections. The data frame may be a Physical Layer Protocol Data Unit (PPDU). The first communication device may be a data frame receiver, the second communication device may be a data frame sender, and the third communication device may be a communication device other than the data frame receiver and the data frame sender. The data frame may include a unicast data frame and a continuous data frame.

The multi-transport connection transmission may be transmission that occupies multiple transmission frequency bands. The transmission frequency band may be a Wi-Fi operating frequency band, such as 2.4 GHz, 5.8 GHz, 6-7 GHz, etc. The transmission frequency band may also be a frequency range of a bandwidth occupied by a transport connection. The frequency range of the bandwidth occupied by each transport connection may belong to the same Wi-Fi operating frequency band, or may belong to different Wi-Fi operating frequency bands.

The second communication device may use one transport connection among multiple transport connections to send the data frame, and the data frame is received by the first communication device. After receiving the data frame, the first communication device can determine reception of the data frame by means of parity check, cyclic redundancy check (CRC), etc., and feed back the reception of the data frame by sending a first acknowledgement message frame to the second communication device. When the data frame is a unicast data frame, the first acknowledgement message frame may be an acknowledgement (ACK) frame or a non-acknowledgement (NACK) frame for the unicast data frame. When the data frame is a continuous data frame, the first acknowledgment message frame may be a block acknowledgment (Block-ACK) frame or the like for the continuous data frame. The first acknowledgment message frame can carry feedback information, which is used to indicate the reception of the data frame. For example, for the unicast data frame, the first acknowledgement message frame may use 1 bit or multiple bits to indicate that the unicast data frame is successfully received or fails to be received. For example, “0” may be used to indicate that the data frame fails to be received, and “1” may be used to indicate that the data frame is successfully received. Also, “I” is used to indicate that the data frame fails to be received, and “0” is used to indicate that the data frame is successfully received. For the continuous data frame, the first acknowledgment message frame can use a bitmap to indicate reception of each data block in the continuous data frame. For example, “0” may be used to indicate that the data block fails to be received, and “1” may be used to indicate that the data block is successfully received. Also, “1” is used to indicate that the data block fails to be received, and “0” is used to indicate that the data block is successfully received.

When determining that the reception of the data frame fails, the first communication device may send a first acknowledgement message frame to indicate that the reception of the data frame fails, and the second communication device may retransmit the data frame. When the unicast data frame fails to be received, the second communication device may retransmit the unicast data frame. When one or more sub-data frames in the continuous data frame fail to be received, the first communication device may use the bitmap in the first acknowledgment message frame to indicate sub-data frames failing to be received, and the second communication device may retransmit the sub-data frames failing to be received.

The first acknowledgment message frame may be provided with duration indication information for indicating the duration. The duration indication information is used to indicate the duration the first communication device continues to occupy the transport connection used for transmitting the first acknowledgement message frame. Herein, the duration of the transport connection continuing to be occupied may be duration of resources for the transport connection continuing to be occupied.

The duration can be used to inform the third communication device that the duration of the communication connection continuing to be occupied. The third communication device stops contending for the communication connection within the duration, so as to reduce transmission interference caused by contention for the communication connection and to improve the data transmission quality.

For example, after receiving the first acknowledgment message frame, the third communication device determines, according to the duration indication information, the duration the first communication device and the second communication device continue to occupy the transport connection, and sets its own Network Allocation Vector (NAV) according to the duration. The third communication device keeps silent on the transport connection within the duration, so that the transmission between the first communication device and the second communication device will not be disturbed. The NAV may be understood as a counter, and used to indicate how long a channel will be occupied. The third communication device can maintain an NAV. A value of the NAV decreases continuously over time. Before the value of the NAV decreases to zero, the third communication device always considers that the transport connection is busy and stops contention and sending of data.

The duration can be determined according to the reception of the data frame. For example, if the data frame is successfully received, only the first acknowledgement message frame is needed to be transmitted subsequently, and thus shorter duration can be set. If the data frame fails to be received, the first acknowledgement message frame, retransmitted data frames, etc., are needed to be transmitted subsequently, and thus longer duration can be set. In this way, the duration of the transport connection continuing to be occupied can be flexibly set according to the reception of the data frame and subsequent transmission requirements. As a result, the waste of resources caused by occupying the transport connection when there is no transmission demand can be reduced, and also the transmission delay caused by re-contention for the transport connection due to insufficient duration can be reduced, thereby improving the transmission efficiency.

After receiving the first acknowledgment message frame, the second communication device may determine the reception of the data frame according to the feedback information, and determine according to the duration indication information the duration of the transport connection continuing to be occupied. If the data frame fails to be received, the data frame can be retransmitted within the duration. The transmission resources for retransmitting the data frame are no longer obtained by means of contention, etc., so that the transmission efficiency of the retransmission of the data frame is improved.

According to embodiments, the duration of the transport connection continuing to be occupied indicated by the first acknowledgment message frame can be determined according to the reception of the data frame. In one aspect, the duration is no longer fixed as the same one, so as to improve the flexibility of setting of the duration. In another aspect, the duration can be set to relatively fixed duration according to subsequent transmission requirements, so as to reduce the waste of resources caused by occupying the transport connection when there is no transmission demand, and also to reduce the transmission delay caused by re-contention for the transport connection due to insufficient duration, thereby improving the transmission efficiency.

In some embodiments, step 101 may include following steps.

When the data frame fails to be received, the duration indication information is determined. The duration indicated by the duration indication information includes transmission duration of a retransmitted data frame.

When the data frame fails to be received, the second communication device needs to retransmit the data frame. Therefore, the duration may include the transmission duration of the retransmitted data frame.

The third communication device may keep silent on the transport connection when the first communication device and the second communication device transmit the retransmitted data frame, so as to reduce interference to the transport connection.

According to embodiments, the transmission resources required for transmitting the retransmitted data frame can be occupied in advance, thus the first communication device or the second communication device may no longer need to obtain transmission resources by means of contention or the like. As a result, the waiting time caused by separately obtaining transmission resources can be reduced, the transmission delay is reduced, and the transmission efficiency is improved.

In some embodiments, the duration indicated by the duration indication information further includes at least one of the following:

transmission duration of the first acknowledgement message frame:

transmission duration of a second acknowledgement message frame corresponding to the retransmitted data frame.

When the data frame fails to be received, the first communication device needs to send the first acknowledgement message frame, the second communication device needs to retransmit the data frame, and the first communication device needs to return a second acknowledgement message frame to the second communication device for the retransmitted data frame received. Therefore, the duration may include the transmission duration of the first acknowledgement message frame, transmission duration of the retransmitted data frame, and the transmission duration of the second acknowledgement message frame corresponding to the retransmitted data frame.

The third communication device may keep silent on the transport connection when the first communication device and the second communication device transmit the first acknowledgement message frame, the retransmitted data frame, and the second acknowledgement message frame corresponding to the retransmitted data frame, so as to reduce interference to the transport connection.

According to embodiments, transmission resources required for transmitting the first acknowledgement message frame, the retransmitted data frame, and the second acknowledgement message frame corresponding to the retransmitted data frame can be occupied in advance. The first communication device or the second communication device may no longer need to obtain the transmission resources by means of contention or the like. As a result, the waiting time caused by separately obtaining transmission resources can be reduced, the transmission delay is reduced, and the transmission efficiency is improved.

In some embodiments, when the data frame is a unicast data frame, the transmission duration of the retransmitted data frame includes transmission duration for retransmitting the unicast data frame.

When the data frame is the unicast data frame, the second communication device needs to retransmit the unicast data frame, thus the transmission duration of the retransmitted data frame is the transmission duration for retransmitting the unicast data frame.

For the unicast data frame, the first acknowledgement message frame may further include retransmission indication information, and the retransmission indication information is used to instruct to retransmit the unicast data frame. After receiving the first acknowledgement message frame, the second communication device retransmits the unicast data frame based on the retransmission indication information.

The retransmission indication information may be located in a type (Type) field in an MAC frame header of the first acknowledgement message frame, and/or a subtype (Subtype) field in the MAC frame header, and/or a more data (more data) field in the MAC frame header.

In some embodiments, w % ben the data frame is a continuous data frame, the first acknowledgement message frame is a block acknowledgement frame.

The transmission duration of the retransmitted data frame includes transmission duration for retransmitting n data blocks that fail to be received in the continuous data frame.

When the data frame is the continuous data frame, the continuous data frame is divided into a plurality of data blocks to be sent respectively. The data block here may be referred to as a sub-data frame. For the continuous data frame, the first acknowledgement message frame may be a block acknowledgement frame, and reception of each data block may be indicated by means of a bitmap or the like. For example, in the bitmap, “t” may be used to indicate that the data block fails to be received, and “I” may be used to indicate that the data block is successfully received.

After receiving the first acknowledgement message frame, the second communication device may retransmit only the data blocks that fail to be received, so as to save transmission resources.

Therefore, the transmission duration of the retransmitted data frame can include the transmission duration for retransmitting data blocks, herein the number of the data blocks retransmitted may be one or more than one.

In some embodiments, the duration indicated by the duration indication information further includes a short interframe space between two adjacent data blocks among the data blocks.

When sending the continuous data frame, the second communication device inserts a short interframe space between adjacent data blocks, thus the duration may include the short interframe space between adjacent data blocks.

In some embodiments, the duration indicated by the duration indication information further includes at least one of the following: a short interframe space between the first acknowledgement message frame and the retransmitted data frame; and a short interframe space between the retransmitted data frame and the second acknowledgement message frame corresponding to the retransmitted data frame.

After receiving the first acknowledgement message frame and before sending the retransmitted data frame, the second communication device needs to process the first acknowledgement message frame received, and to process (such as packeting) the retransmitted data frame for transmission. Therefore, a short interframe space can be set between the first acknowledgement message frame and the retransmitted data frame to provide processing time for the second communication device.

After receiving the retransmitted data frame and before sending the second acknowledgement message frame for the retransmitted data frame, the first communication device needs to determine reception of the retransmitted data frame, etc. Therefore, a short interframe space can be set between the retransmitted data frame and the second acknowledgement message frame to provide processing time for the first communication device.

According to embodiments, the duration is set based on the duration required for retransmitting the data frame, the accuracy of the duration can be improved, thereby meeting requirements for retransmission of the data frame.

In some embodiments, step 101 may include following steps.

In response to the data frame failing to be received, the duration indication information is determined. In some embodiments, an expression of the duration indicated by the duration indication information includes:

2*ACK+data frame length+2*SIFS,

herein, 2*ACK represents transmission duration of the first acknowledgement message frame, and transmission duration of the second acknowledgement message frame corresponding to the retransmitted data frame, the data frame length represents transmission duration required for retransmitting the unicast data frame when the data frame is the unicast data frame; 2*SIFS represents two short interframe spaces.

In some embodiments, for a unicast data frame that fails to be received, the duration may be as follows: 2*ACK+unicast data frame transmission duration+2*SIFS, where 2*ACK represents transmission duration of the first acknowledgement message frame and transmission duration of the second acknowledgement message frame, 2*SIFS represents two short interframe spaces. Herein, the two short interframe spaces may be the short interframe space between the first acknowledgement message frame and the retransmitted data frame, and the short interframe space between the retransmitted data frame and the second acknowledgement message frame.

In some embodiments, step 101 may include following steps.

In response to the data frame failing to be received, the duration indication information is determined. In some embodiments, an expression of the duration indicated by the duration indication information includes:

2*BA+n*(data block length)+(1+n)*SIFS,

herein, 2*BA represents transmission duration of the first acknowledgement message frame, and transmission duration of the second acknowledgement message frame corresponding to the retransmitted data frame; the n*(data block length) represents transmission duration required for retransmitting n data blocks that fail to be received in the continuous data frame when the data frame is the continuous data frame; (1+n)*SIFS represents (n+1) short interframe spaces.

In some embodiments, for a continuous data frame containing n data blocks that fail to be received, the duration may be as follows: 2*BA+n*(data block transmission duration)+(1+n)*SIFS, where 2*BA represents transmission duration of the first acknowledgement message frame and transmission duration of the second acknowledgement message frame, (1+n)*SIFS represents (1+n) short interframe spaces, and the n*(data block transmission duration) represents transmission duration of n data blocks. Herein, n represents the number of retransmitted data blocks, where n may be a positive integer greater than or equal to 1, and n is less than or equal to the number of data blocks contained in the continuous data frame. The (n+1) short interframe spaces may be the short interframe space between the first acknowledgement message frame and the retransmitted data frame, the short interframe space between the retransmitted data frame and the second acknowledgement message frame, and short interframe spaces between n retransmitted data blocks.

In some embodiments, the duration indication information includes:

a duration field in an MAC (Media Access Control) frame header of the first acknowledgement message frame;

and

a length field in a physical frame header of the first acknowledgment message frame.

The duration can be indicated by the duration field in the MAC frame header and the length field in the physical frame header.

The second communication device may determine the duration through the duration field, and retransmit the data frame, etc., within the duration.

If the third communication device and the first communication device belong to the same Basic Service Set (BSS), the MAC frame header can be parsed, and the duration can be determined through the duration field. Then, the third communication device can set the NAV according to the duration indicated by the duration field.

If the third communication device and the first communication device do not belong to the same BSS, after receiving the first acknowledgement message frame, the third communication device may first parse the physical frame header, and determine the duration through the length field. Since the third communication device and the first communication device do not belong to the same BSS, the third communication device does not parse the MAC frame header after parsing the physical frame header. Then, the third communication device can set the NAV according to the duration indicated by the length field. In this way, the duration can be indicated in the duration field and the length field respectively, so that the adaptability of the first acknowledgment message frame to communication devices of different BSSs is improved.

After receiving the first acknowledgment message frame, the third communication device compares the duration with backoff duration indicated by its own NAV. If the duration is greater than the backoff duration, it means that the third communication device needs to be silent for a longer time. Therefore, the third communication device can update the backoff duration with the duration.

If the duration is less than or equal to the backoff duration, it means that the duration within which the third communication device keeps silent exceeds the duration declared to be occupied by the first communication device and the second communication device. Therefore, the current NAV can be maintained.

In some embodiments, step 101 may include following steps, in response to successful reception of the data frame, the duration indicated by the duration indication information is determined as 0.

When the data frame is successfully received, the first acknowledgment message frame is of small information amount, thus the duration can be set to 0, indicating that the first communication device and the second communication device will no longer occupy the transport connection.

As shown in FIG. 2, exemplary embodiments provide a data transmission method. The data transmission method may be applied to a second communication device for wireless communication. The data transmission method may include following steps.

In a step 201, a first acknowledgement message frame is received.

In a step 202, reception of a data frame in multi-transport connection transmission is determined according to feedback information in the first acknowledgment message frame.

In a step 203, duration of a transport connection continuing to be occupied is determined according to duration indication information in the first acknowledgement message frame. The duration indication information is based on the reception of the data frame.

The wireless communication here may be Wi-Fi communication using a standard such as IEEE802.11be. A first communication device, a second communication device and a third communication device may be wireless stations (STAs) or wireless access points (APs), etc., in the Wi-Fi communication. The data frame may be a data frame that is separately transmitted in each of multiple transport connections. The data frame may be a Physical Layer Protocol Data Unit (PPDU). The first communication device may be a data frame receiver, the second communication device may be a data frame sender, and the third communication device may be a communication device other than the data frame receiver and the data frame sender. The data frame may include a unicast data frame and a continuous data frame.

The multi-transport connection transmission may be transmission that occupies multiple transmission frequency bands. The transmission frequency band may be a Wi-Fi operating frequency band, such as 2.4 GHz, 5.8 GHz, 6-7 GHz, etc. The transmission frequency band may also be a frequency range of a bandwidth occupied by a transport connection. The frequency range of the bandwidth occupied by each transport connection may belong to the same Wi-Fi operating frequency band, or may belong to different Wi-Fi operating frequency bands.

The second communication device may use one transport connection among multiple transport connections to send the data frame, and the data frame is received by the first communication device. After receiving the data frame, the first communication device can determine reception of the data frame by means of parity check, cyclic redundancy check (CRC), etc., and feed back the reception of the data frame by sending a first acknowledgement message frame to the second communication device. When the data frame is a unicast data frame, the first acknowledgement message frame may be an acknowledgement (ACK) frame or a non-acknowledgement (NACK) frame for the unicast data frame. When the data frame is a continuous data frame, the first acknowledgment message frame may be a block acknowledgment (Block-ACK) frame or the like for the continuous data frame.

The first acknowledgment message frame can carry feedback information, which is used to indicate the reception of the data frame. For example, for the unicast data frame, the first acknowledgement message frame may use 1 bit or multiple bits to indicate that the unicast data frame is successfully received or fails to be received. For example, “0” may be used to indicate that the data frame fails to be received, and “1” may be used to indicate that the data frame is successfully received. Also, “1” is used to indicate that the data frame fails to be received, and “0” is used to indicate that the data frame is successfully received. For the continuous data frame, the first acknowledgment message frame can use a bitmap to indicate reception of each data block in the continuous data frame. For example, “0” may be used to indicate that the data block fails to be received, and “1” may be used to indicate that the data block is successfully received. Also, “1” is used to indicate that the data block fails to be received, and “0” is used to indicate that the data block is successfully received.

When determining that the reception of the data frame fails, the first communication device may send a first acknowledgement message frame to indicate that the reception of the data frame fails, and the second communication device may retransmit the data frame. When the unicast data frame fails to be received, the second communication device may retransmit the unicast data frame. When one or more sub-data frames in the continuous data frame fail to be received, the first communication device may use the bitmap in the first acknowledgment message frame to indicate sub-data frames failing to be received, and the second communication device may retransmit the sub-data frames failing to be received.

The first acknowledgment message frame may be provided with duration indication information for indicating the duration. The duration indication information is used to indicate the duration the first communication device continues to occupy the transport connection used for transmitting the first acknowledgement message frame. Herein, the duration of the transport connection continuing to be occupied may be duration of resources for the transport connection continuing to be occupied. The third communication device stops contending for the communication connection within the duration, so as to reduce transmission interference caused by contention for the communication connection and improve the data transmission quality.

For example, the duration can be used to inform the third communication device that the duration of the communication connection continuing to be occupied. After receiving the first acknowledgment message frame, the third communication device determines, according to the duration indication information, the duration the first communication device and the second communication device continue to occupy the transport connection, and sets its own NAV according to the duration. The third communication device keeps silent on the transport connection within the duration, so that the transmission between the first communication device and the second communication device will not be disturbed. The NAV may be understood as a counter, and used to indicate how long a channel will be occupied. The third communication device can maintain an NAV. A value of the NAV decreases continuously over time. Before the value of the NAV decreases to zero, the third communication device always considers that the transport connection is busy and stops contention and sending of data.

The duration can be determined according to the reception of the data frame. For example, if the data frame is successfully received, only the first acknowledgement message frame is needed to be transmitted subsequently, and thus shorter duration can be set. If the data frame fails to be received, the first acknowledgement message frame, retransmitted data frames, etc., are needed to be transmitted subsequently, and thus longer duration can be set. In this way, the duration of the transport connection continuing to be occupied can be flexibly set according to the reception of the data frame and subsequent transmission requirements. As a result, the waste of resources caused by occupying the transport connection when there is no transmission demand can be reduced, and also the transmission delay caused by re-contention for the transport connection due to insufficient duration can be reduced, thereby improving the transmission efficiency.

After receiving the first acknowledgment message frame, the second communication device may determine the reception of the data frame according to the feedback information, and determine according to the duration indication information the duration of the transport connection continuing to be occupied. If the data frame fails to be received, the data frame can be retransmitted within the duration. The transmission resources for retransmitting the data frame are no longer obtained by means of contention, etc., so that the transmission efficiency of the retransmission of the data frame is improved.

After receiving the first acknowledgment message frame, the third communication device determines, according to the duration indication information, the duration the first communication device and the second communication device continue to occupy the transport connection, and sets its own NAV according to the duration. The third communication device keeps silent on the transport connection within the duration, so that the transmission between the first communication device and the second communication device will not be disturbed. The NAV may be understood as a counter, and used to indicate how long a channel will be occupied. The third communication device can maintain an NAV. A value of the NAV decreases continuously over time. Before the value of the NAV decreases to zero, the third communication device always considers that the transport connection is busy and stops contention and sending of data.

According to embodiments, the duration of the transport connection continuing to be occupied indicated by the first acknowledgment message frame can be determined according to the reception of the data frame. In one aspect, the duration is no longer fixed as the same one, so as to improve the flexibility of setting of the duration. In another aspect, the duration can be set to relatively fixed duration according to subsequent transmission requirements, so as to reduce the waste of resources caused by occupying the transport connection when there is no transmission demand, and also to reduce the transmission delay caused by re-contention for the transport connection due to insufficient duration, thereby improving the transmission efficiency.

In some embodiments, when the data frame fails to be received, the duration indicated by the duration indication information includes transmission duration for retransmitting the data frame.

When the data frame fails to be received, the second communication device needs to retransmit the data frame. Therefore, the duration may include transmission duration of a retransmitted data frame.

The third communication device may keep silent on the transport connection when the first communication device and the second communication device transmit the retransmitted data frame, so as to reduce interference to the transport connection.

According to embodiments, the transmission resources required for transmitting the retransmitted data frame can be occupied in advance, thus the first communication device or the second communication device may no longer need to obtain transmission resources by means of contention or the like. As a result, the waiting time caused by separately obtaining transmission resources can be reduced, the transmission delay is reduced, and the transmission efficiency is improved.

In some embodiments, the duration indicated by the duration indication information further includes at least one of the following:

transmission duration of the first acknowledgement message frame,

transmission duration of a second acknowledgement message frame corresponding to the retransmitted data frame.

When the data frame fails to be received, the first communication device needs to send the first acknowledgement message frame, the second communication device needs to retransmit the data frame, and the first communication device needs to return a second acknowledgement message frame to the second communication device for the retransmitted data frame received. Therefore, the duration may include the transmission duration of the first acknowledgement message frame, transmission duration of the retransmitted data frame, and the transmission duration of the second acknowledgement message frame corresponding to the retransmitted data frame.

The third communication device may keep silent on the transport connection when the first communication device and the second communication device transmit the first acknowledgement message frame, the retransmitted data frame, and the second acknowledgement message frame corresponding to the retransmitted data frame, so as to reduce interference to the transport connection.

According to embodiments, transmission resources required for transmitting the first acknowledgement message frame, the retransmitted data frame, and the second acknowledgement message frame corresponding to the retransmitted data frame can be occupied in advance. The first communication device or the second communication device may no longer need to obtain the transmission resources by means of contention or the like. As a result, the waiting time caused by separately obtaining transmission resources can be reduced, the transmission delay is reduced, and the transmission efficiency is improved.

In some embodiments, when the data frame is a unicast data frame, the transmission duration of the retransmitted data frame includes transmission duration for retransmitting the unicast data frame.

When the data frame is the unicast data frame, the second communication device needs to retransmit the unicast data frame, thus the transmission duration of the retransmitted data frame is the transmission duration for retransmitting the unicast data frame.

For example, for a unicast data frame that fails to be received, the duration may be as follows: 2*ACK+unicast data frame transmission duration+2*SIFS, where 2*ACK represents transmission duration of the first acknowledgement message frame and transmission duration of the second acknowledgement message frame, and 2*SIFS represents two short interframe spaces.

For the unicast data frame, the first acknowledgement message frame may further include retransmission indication information, and the retransmission indication information is used to instruct to retransmit the unicast data frame. After receiving the first acknowledgement message frame, the second communication device retransmits the unicast data frame based on the retransmission indication information.

The retransmission indication information may be located in a type (Type) field in an MAC frame header of the first acknowledgement message frame, and/or a subtype (Subtype) field in the MAC frame header, and/or a more data (more data) field in the MAC frame header.

In some embodiments, when the data frame is a continuous data frame, the first acknowledgement message frame is a block acknowledgement frame.

The transmission duration of the retransmitted data frame includes transmission duration for retransmitting n data blocks that fail to be received in the continuous data frame.

When the data frame is the continuous data frame, the continuous data frame is divided into a plurality of data blocks to be sent respectively. The data block here may be referred to as a sub-data frame. For the continuous data frame, the first acknowledgement message frame may be a block acknowledgement frame, and reception of each data block may be indicated by means of a bitmap or the like. For example, in the bitmap, “0” may be used to indicate that the data block fails to be received, and “1” may be used to indicate that the data block is successfully received.

After receiving the first acknowledgement message frame, the second communication device may retransmit only the data blocks that fail to be received, so as to save transmission resources.

Therefore, the transmission duration of the retransmitted data frame can include the transmission duration for retransmitting data blocks, herein the number of the data blocks retransmitted may be one or more than one.

In some embodiments, the duration indicated by the duration indication information further includes a short interframe space between two adjacent data blocks among the data blocks.

When sending the continuous data frame, the second communication device inserts a short interframe space between adjacent data blocks, thus the duration may include the short interframe space between adjacent data blocks.

For example, for a continuous data frame containing n data blocks that fail to be received, the duration may be as follows: 2*BA+n*(data block transmission duration)+(1+n)*SIFS, where 2*BA represents transmission duration of the first acknowledgement message frame and transmission duration of the second acknowledgement message frame, (1+n)*SIFS represents (1+n) short interframe spaces, and the n*(data block transmission duration) represents transmission duration of n data blocks. Herein, n represents the number of retransmitted data blocks, where n may be a positive integer greater than or equal to 1, and n is less than or equal to the number of data blocks contained in the continuous data frame.

In some embodiments, the duration indicated by the duration indication information further includes a short interframe space between the first acknowledgement message frame and the retransmitted data frame, and a short interframe space between the retransmitted data frame and the second acknowledgement message frame corresponding to the retransmitted data frame.

After receiving the first acknowledgement message frame and before sending the retransmitted data frame, the second communication device needs to process the first acknowledgement message frame received, and to process (such as packeting) the retransmitted data frame for transmission. Therefore, a short interframe space can be set between the first acknowledgement message frame and the retransmitted data frame to provide processing time for the second communication device.

After receiving the retransmitted data frame and before sending the second acknowledgement message frame for the retransmitted data frame, the first communication device needs to determine reception of the retransmitted data frame, etc. Therefore, a short interframe space can be set between the retransmitted data frame and the second acknowledgement message frame to provide processing time for the first communication device.

According to embodiments, the duration is set based on the duration required for retransmitting the data frame, the accuracy of the duration can be improved, thereby meeting requirements for retransmission of the data frame.

In some embodiments, when the data frame fails to be received, an expression of the duration indicated by the duration indication information includes:

2*ACK+data frame length+2*SIFS,

herein, 2*ACK represents transmission duration of the first acknowledgement message frame, and transmission duration of the second acknowledgement message frame corresponding to the retransmitted data frame; the data frame length represents transmission duration required for retransmitting the unicast data frame when the data frame is the unicast data frame; 2*SIFS represents two short interframe spaces.

In some embodiments, for a unicast data frame that fails to be received, the duration may be as follows: 2*ACK+unicast data frame transmission duration+2*SIFS, where 2*ACK represents transmission duration of the first acknowledgement message frame and transmission duration of the second acknowledgement message frame, 2*SIFS represents two short interframe spaces. Herein, the two short interframe spaces may be the short interframe space between the first acknowledgement message frame and the retransmitted data frame, and the short interframe space between the retransmitted data frame and the second acknowledgement message frame.

In some embodiments, when the data frame fails to be received, an expression of the duration indicated by the duration indication information includes:

2*BA+n*(data block length)+(1+n)*SIFS,

herein, 2*BA represents transmission duration of the first acknowledgement message frame, and transmission duration of the second acknowledgement message frame corresponding to the retransmitted data frame; the n*(data block length) represents transmission duration required for retransmitting n data blocks that fail to be received in the continuous data frame when the data frame is the continuous data frame; (1+n)*SIFS represents (n+1) short interframe spaces.

In some embodiments, for a continuous data frame containing n data blocks that fail to be received, the duration may be as follows: 2*BA+n*(data block transmission duration)+(1+n)*SIFS, where 2*BA represents transmission duration of the first acknowledgement message frame and transmission duration of the second acknowledgement message frame, (1+n)*SIFS represents (1+n) short interframe spaces, and the n*(data block transmission duration) represents transmission duration of n data blocks. Herein, n represents the number of retransmitted data blocks, where n may be a positive integer greater than or equal to 1, and n is less than or equal to the number of data blocks contained in the continuous data frame. The (n+1) short interframe spaces may be the short interframe space between the first acknowledgement message frame and the retransmitted data frame, the short interframe space between the retransmitted data frame and the second acknowledgement message frame, and short interframe spaces between n retransmitted data blocks.

In some embodiments, step 203 may include following steps,

the duration of the transport connection continuing to be occupied is determined according to indication of a duration field in an MAC (Media Access Control) frame header of the first acknowledgement message frame.

The duration can be indicated by the duration field in the MAC frame header and the length field in the physical frame header.

The second communication device may determine the duration through the duration field, and retransmit the data frame, etc., within the duration.

If the third communication device and the first communication device belong to the same BSS, the MAC frame header can be parsed, and the duration can be determined through the duration field. Then, the third communication device can set the NAV according to the duration indicated by the duration field.

If the third communication device and the first communication device do not belong to the same BSS, after receiving the first acknowledgement message frame, the third communication device may first parse the physical frame header, and determine the duration through the length field. Since the third communication device and the first communication device do not belong to the same BSS, the third communication device does not parse the MAC frame header after parsing the physical frame header. Then, the third communication device can set the NAV according to the duration indicated by the length field. In this way, the duration can be indicated in the duration field and the length field respectively, so that the adaptability of the first acknowledgment message frame to communication devices of different BSSs is improved.

After receiving the first acknowledgment message frame, the third communication device compares the duration with backoff duration indicated by its own NAV. If the duration is greater than the backoff duration, it means that the third communication device needs to be silent for a longer time. Therefore, the third communication device can update the backoff duration with the duration.

If the duration is less than or equal to the backoff duration, it means that the duration within which the third communication device keeps silent exceeds the duration declared to be occupied by the first communication device and the second communication device. Therefore, the current NAV can be maintained.

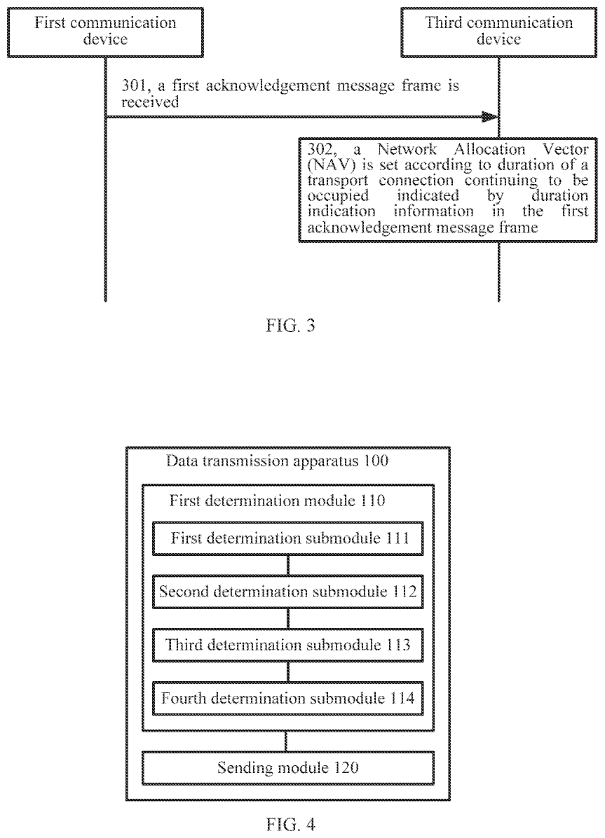

As shown in FIG. 3, exemplary embodiments provide a data transmission method. The data transmission method may be applied to a third communication device for wireless communication. The data transmission method may include following steps.

In a step 301, a first acknowledgement message frame is received.

In a step 302, a Network Allocation Vector (NAV) is set according to duration of a transport connection continuing to be occupied indicated by duration indication information in the first acknowledgement message frame. The duration indication information is based on reception of a data frame in multi-transport connection transmission.

The wireless communication here may be Wi-Fi communication using a standard such as IEEE802.11be. A first communication device, a second communication device and a third communication device may be wireless stations (STAs) or wireless access points (APs), etc., in the Wi-Fi communication. The data frame may be a data frame that is separately transmitted in each of multiple transport connections. The data frame may be a Physical Layer Protocol Data Unit (PPDU). The first communication device may be a data frame receiver, the second communication device may be a data frame sender, and the third communication device may be a communication device other than the data frame receiver and the data frame sender. The data frame may include a unicast data frame and a continuous data frame.

The multi-transport connection transmission may be transmission that occupies multiple transmission frequency bands. The transmission frequency band may be a Wi-Fi operating frequency band, such as 2.4 GHz, 5.8 GHz, 6-7 GHz, etc. The transmission frequency band may also be a frequency range of a bandwidth occupied by a transport connection. The frequency range of the bandwidth occupied by each transport connection may belong to the same Wi-Fi operating frequency band, or may belong to different Wi-Fi operating frequency bands.

The second communication device may use one transport connection among multiple transport connections to send the data frame, and the data frame is received by the first communication device. After receiving the data frame, the first communication device can determine reception of the data frame by means of panty check, cyclic redundancy check (CRC), etc., and feed back the reception of the data frame by sending a first acknowledgement message frame to the second communication device. When the data frame is a unicast data frame, the first acknowledgement message frame may be an acknowledgement (ACK) frame or a non-acknowledgement (NACK) frame for the unicast data frame. When the data frame is a continuous data frame, the first acknowledgment message frame may be a block acknowledgment (Block-ACK) frame or the like for the continuous data frame.

The first acknowledgment message frame can carry feedback information, which is used to indicate the reception of the data frame. For example, for the unicast data frame, the first acknowledgement message frame may use 1 bit or multiple bits to indicate that the unicast data frame is successfully received or fails to be received. For example, “0” may be used to indicate that the data frame fails to be received, and “1” may be used to indicate that the data frame is successfully received. Also, “I” is used to indicate that the data frame fails to be received, and “0” is used to indicate that the data frame is successfully received. For the continuous data frame, the first acknowledgment message frame can use a bitmap to indicate reception of each data block in the continuous data frame. For example, “0” may be used to indicate that the data block fails to be received, and “1” may be used to indicate that the data block is successfully received. Also, “1” is used to indicate that the data block fails to be received, and “0” is used to indicate that the data block is successfully received.

When determining that the reception of the data frame fails, the first communication device may send a first acknowledgement message frame to indicate that the reception of the data frame fails, and the second communication device may retransmit the data frame. When the unicast data frame fails to be received, the second communication device may retransmit the unicast data frame. When one or more sub-data frames in the continuous data frame fail to be received, the first communication device may use the bitmap in the first acknowledgment message frame to indicate sub-data frames failing to be received, and the second communication device may retransmit the sub-data frames failing to be received.

The first acknowledgment message frame may be provided with duration indication information for indicating the duration. The duration indication information is used to indicate the duration the first communication device continues to occupy the transport connection used for transmitting the first acknowledgement message frame. Herein, the duration of the transport connection continuing to be occupied may be duration of resources for the transport connection continuing to be occupied. The third communication device stops contending for the communication connection within the duration, so as to reduce transmission interference caused by contention for the communication connection and improve the data transmission quality.

For example, the duration can be used to inform the third communication device that the duration of the communication connection continuing to be occupied. After receiving the first acknowledgment message frame, the third communication device determines, according to the duration indication information, the duration the first communication device and the second communication device continue to occupy the transport connection, and sets its own NAV according to the duration. The third communication device keeps silent on the transport connection within the duration, so that the transmission between the first communication device and the second communication device will not be disturbed. The NAV may be understood as a counter, and used to indicate how long a channel will be occupied. The third communication device can maintain an NAV. A value of the NAV decreases continuously over time. Before the value of the NAV decreases to zero, the third communication device always considers that the transport connection is busy and stops contention and sending of data.

The duration can be determined according to the reception of the data frame. For example, if the data frame is successfully received, only the first acknowledgement message frame is needed to be transmitted subsequently, and thus shorter duration can be set. If the data frame fails to be received, the first acknowledgement message frame, retransmitted data frames, etc., are needed to be transmitted subsequently, and thus longer duration can be set. In this way, the duration of the transport connection continuing to be occupied can be flexibly set according to the reception of the data frame and subsequent transmission requirements. As a result, the waste of resources caused by occupying the transport connection when there is no transmission demand can be reduced, and also the transmission delay caused by re-contention for the transport connection due to insufficient duration can be reduced, thereby improving the transmission efficiency.

After receiving the first acknowledgment message frame, the second communication device may determine the reception of the data frame according to the feedback information, and determine according to the duration indication information the duration of the transport connection continuing to be occupied. If the data frame fails to be received, the data frame can be retransmitted within the duration. The transmission resources for retransmitting the data frame are no longer obtained by means of contention, etc., so that the transmission efficiency of the retransmission of the data frame is improved.

After receiving the first acknowledgment message frame, the third communication device determines, according to the duration indication information, the duration the first communication device and the second communication device continue to occupy the transport connection, and sets its own NAV according to the duration. The third communication device keeps silent on the transport connection within the duration, so that the transmission between the first communication device and the second communication device will not be disturbed. The NAV may be understood as a counter, and used to indicate how long a channel will be occupied. The third communication device can maintain an NAV. A value of the NAV decreases continuously over time. Before the value of the NAV decreases to zero, the third communication device always considers that the transport connection is busy and stops contention and sending of data.

According to embodiments, the duration of the transport connection continuing to be occupied indicated by the first acknowledgment message frame can be determined according to the reception of the data frame. In one aspect, the duration is no longer fixed as the same one, so as to improve the flexibility of setting of the duration. In another aspect, the duration can be set to relatively fixed duration according to subsequent transmission requirements, so as to reduce the waste of resources caused by occupying the transport connection when there is no transmission demand, and also to reduce the transmission delay caused by re-contention for the transport connection due to insufficient duration, thereby improving the transmission efficiency.

In some embodiments, when the data frame fails to be received, the duration indicated by the duration indication information includes transmission duration for retransmitting the data frame.

When the data frame fails to be received, the second communication device needs to retransmit the data frame. Therefore, the duration may include transmission duration of a retransmitted data frame.

The third communication device may keep silent on the transport connection when the first communication device and the second communication device transmit the retransmitted data frame, so as to reduce interference to the transport connection.

According to embodiments, the transmission resources required for transmitting the retransmitted data frame can be occupied in advance, thus the first communication device or the second communication device may no longer need to obtain transmission resources by means of contention or the like. As a result, the waiting time caused by separately obtaining transmission resources can be reduced, the transmission delay is reduced, and the transmission efficiency is improved.

In some embodiments, the duration indicated by the duration indication information further includes at least one of the following:

transmission duration of the first acknowledgement message frame;

transmission duration of a second acknowledgement message frame corresponding to the retransmitted data frame.

When the data frame fails to be received, the first communication device needs to send the first acknowledgement message frame, the second communication device needs to retransmit the data frame, and the first communication device needs to return a second acknowledgement message frame to the second communication device for the retransmitted data frame received. Therefore, the duration may include the transmission duration of the first acknowledgement message frame, transmission duration of the retransmitted data frame, and the transmission duration of the second acknowledgement message frame corresponding to the retransmitted data frame.

The third communication device may keep silent on the transport connection when the first communication device and the second communication device transmit the first acknowledgement message frame, the retransmitted data frame, and the second acknowledgement message frame corresponding to the retransmitted data frame, so as to reduce interference to the transport connection.

According to embodiments, transmission resources required for transmitting the first acknowledgement message frame, the retransmitted data frame, and the second acknowledgement message frame corresponding to the retransmitted data frame can be occupied in advance. The first communication device or the second communication device may no longer need to obtain the transmission resources by means of contention or the like. As a result, the waiting time caused by separately obtaining transmission resources can be reduced, the transmission delay is reduced, and the transmission efficiency is improved.

In some embodiments, when the data frame is a unicast data frame, the transmission duration of the retransmitted data frame includes transmission duration for retransmitting the unicast data frame.

When the data frame is the unicast data frame, the second communication device needs to retransmit the unicast data frame, thus the transmission duration of the retransmitted data frame is the transmission duration for retransmitting the unicast data frame.

For example, for a unicast data frame that fails to be received, the duration may be as follows: 2*ACK+unicast data frame transmission duration+2*SIFS, where 2*ACK represents transmission duration of the first acknowledgement message frame and transmission duration of the second acknowledgement message frame, and 2*SIFS represents two short interframe spaces.

For the unicast data frame, the first acknowledgement message frame may further include retransmission indication information, and the retransmission indication information is used to instruct to retransmit the unicast data frame. After receiving the first acknowledgement message frame, the second communication device retransmits the unicast data frame based on the retransmission indication information.

The retransmission indication information may be located in a type (Type) field in an MAC frame header of the first acknowledgement message frame, and/or a subtype (Subtype) field in the MAC frame header, and/or a more data (more data) field in the MAC frame header.

In some embodiments, when the data frame is a continuous data frame, the first acknowledgement message frame is a block acknowledgement frame.

The transmission duration of the retransmitted data frame includes transmission duration for retransmitting n data blocks that fail to be received in the continuous data frame.

When the data frame is the continuous data frame, the continuous data frame is divided into a plurality of data blocks to be sent respectively. The data block here may be referred to as a sub-data frame. For the continuous data frame, the first acknowledgement message frame may be a block acknowledgement frame, and reception of each data block may be indicated by means of a bitmap or the like. For example, in the bitmap, “0” may be used to indicate that the data block fails to be received, and “1” may be used to indicate that the data block is successfully received.

After receiving the first acknowledgement message frame, the second communication device may retransmit only the data blocks that fail to be received, so as to save transmission resources.

Therefore, the transmission duration of the retransmitted data frame can include the transmission duration for retransmitting data blocks, herein the number of the data block retransmitted may be one or more than one.

In some embodiments, the duration indicated by the duration indication information further includes a short interframe space between two adjacent data blocks among the data blocks.

When sending the continuous data frame, the second communication device inserts a short interframe space between adjacent data blocks, thus the duration may include the short interframe space between adjacent data blocks.

For example, for a continuous data frame containing n data blocks that fail to be received, the duration may be as follows: 2*BA+n*(data block transmission duration)+(1+n)*SIFS, where 2*BA represents transmission duration of the first acknowledgement message frame and transmission duration of the second acknowledgement message frame, (1+n)*SIFS represents (1+n) short interframe spaces, and the n*(data block transmission duration) represents transmission duration of n data blocks. Herein, n represents the number of retransmitted data blocks, where n may be a positive integer greater than or equal to 1, and n is less than or equal to the number of data blocks contained in the continuous data frame.

In some embodiments, the duration indicated by the duration indication information further includes a short interframe space between the first acknowledgement message frame and the retransmitted data frame, and a short interframe space between the retransmitted data frame and the second acknowledgement message frame corresponding to the retransmitted data frame.

After receiving the first acknowledgement message frame and before sending the retransmitted data frame, the second communication device needs to process the first acknowledgement message frame received, and to process (such as packeting) the retransmitted data frame for transmission. Therefore, a short interframe space can be set between the first acknowledgement message frame and the retransmitted data frame to provide processing time for the second communication device.

After receiving the retransmitted data frame and before sending the second acknowledgement message frame for the retransmitted data frame, the first communication device needs to determine reception of the retransmitted data frame, etc. Therefore, a short interframe space can be set between the retransmitted data frame and the second acknowledgement message frame to provide processing time for the first communication device.

According to embodiments, the duration is set based on the duration required for retransmitting the data frame, the accuracy of the duration can be improved, thereby meeting requirements for retransmission of the data frame.

In some embodiments, when the data frame fails to be received, an expression of the duration indicated by the duration indication information includes:

2*ACK+data frame length+2*SIFS,

herein, 2*ACK represents transmission duration of the first acknowledgement message frame, and transmission duration of the second acknowledgement message frame corresponding to the retransmitted data frame; the data frame length represents transmission duration required for retransmitting the unicast data frame when the data frame is the unicast data frame; 2*SIFS represents two short interframe spaces.

In some embodiments, for a unicast data frame that fails to be received, the duration may be as follows: 2*ACK+unicast data frame transmission duration+2*SIFS, where 2*ACK represents transmission duration of the first acknowledgement message frame and transmission duration of the second acknowledgement message frame, 2*SIFS represents two short interframe spaces. Herein, the two short interframe spaces may be the short interframe space between the first acknowledgement message frame and the retransmitted data frame, and the short interframe space between the retransmitted data frame and the second acknowledgement message frame.

In some embodiments, when the data frame fails to be received, an expression of the duration indicated by the duration indication information includes:

2*BA+n*(data block length)+(1+n)*SIFS,

herein, 2*BA represents transmission duration of the first acknowledgement message frame, and transmission duration of the second acknowledgement message frame corresponding to the retransmitted data frame; the n*(data block length) represents transmission duration required for retransmitting n data blocks that fail to be received in the continuous data frame when the data frame is the continuous data frame; (1+n)*SIFS represents (n+1) short interframe spaces.

In some embodiments, for a continuous data frame containing n data blocks that fail to be received, the duration may be as follows: 2*BA+n*(data block transmission duration)+(1+n)*SIFS, where 2*BA represents transmission duration of the first acknowledgement message frame and transmission duration of the second acknowledgement message frame, (1+n)*SIFS represents (1+n) short interframe spaces, and the n*(data block transmission duration) represents transmission duration of n data blocks. Herein, n represents the number of retransmitted data blocks, where n may be a positive integer greater than or equal to 1, and n is less than or equal to the number of data blocks contained in the continuous data frame. The (n+1) short interframe spaces may be the short interframe space between the first acknowledgement message frame and the retransmitted data frame, the short interframe space between the retransmitted data frame and the second acknowledgement message frame, and short interframe spaces between n retransmitted data blocks.

In some embodiments, step 302 may include following steps.

the NAV is set according to the duration of the transport connection continuing to be occupied indicated by a duration field in an MAC frame header of the first acknowledgement message frame,

or

the NAV is set according to the duration of the transport connection continuing to be occupied indicated by a length field in a physical frame header of the first acknowledgment message frame.

The duration can be indicated by the duration field in the MAC frame header and the length field in the physical frame header.

The second communication device may determine the duration through the duration field, and retransmit the data frame, etc., within the duration.

If the third communication device and the first communication device belong to the same BSS, the MAC frame header can be parsed, and the duration can be determined through the duration field. Then, the third communication device can set the NAV according to the duration indicated by the duration field.

If the third communication device and the first communication device do not belong to the same BSS, after receiving the first acknowledgement message frame, the third communication device may first parse the physical frame header, and determine the duration through the length field. Since the third communication device and the first communication device do not belong to the same BSS, the third communication device does not parse the MAC frame header after parsing the physical frame header. Then, the third communication device can set the NAV according to the duration indicated by the length field. In this way, the duration can be indicated in the duration field and the length field respectively, so that the adaptability of the first acknowledgment message frame to communication devices of different BSSs is improved.

If the duration is less than or equal to the backoff duration, it means that the duration within which the third communication device keeps silent exceeds the duration declared to be occupied by the first communication device and the second communication device. Therefore, the current NAV can be maintained.

In some embodiments, step 302 may include following steps.

In response to the duration being greater than the backoff duration to keep silent on the transport connection, indicated by the NAV, the backoff duration is updated using the duration.

After receiving the first acknowledgment message frame, the third communication device compares the duration with the backoff duration indicated by its own NAV. If the duration is greater than the backoff duration, it means that the third communication device needs to be silent for a longer time. Therefore, the third communication device can update the backoff duration with the duration.

If the duration is less than or equal to the backoff duration, it means that the duration within which the third communication device keeps silent exceeds the duration declared to be occupied by the first communication device and the second communication device. Therefore, the current NAV can be maintained.

In some embodiments, step 302 may include following steps.

In response to the duration being less than or equal to the backoff duration to keep silent on the transport connection, indicated by the NAV, the NAV is maintained.

Embodiments of the present disclosure also provide a data transmission method.

According to the method, a data frame receiver sends, in response to receiving a data frame from a data frame sender, an acknowledgement (ACK) frame to the data frame sender, so that the data frame sender can determine whether the data frame is correctly received.

In some embodiments, when the data frame is a unicast data frame, and when the data frame receiver determines that the unicast data frame is not correctly received, a duration field in a first ACK frame is set to.

2*ACK+2*SIFS+unicast data frame transmission duration,

where the unicast data frame transmission duration represents duration for retransmitting the unicast frame; 2*ACK represents transmission duration of the first ACK frame, and transmission duration of a second ACK corresponding to retransmitted unicast data frame; 2*SIFS represents short interframe spaces between the retransmitted unicast data frame and the first ACK frame, and between the retransmitted unicast data frame and the second ACK frame.

In some other embodiments, when the data frame is a continuous data frame, the data frame receiver can feed back using a block acknowledgment (BA, Block ACK) frame. When the data frame receiver determines that the continuous data frame has not been correctly received, a duration field in a first block acknowledgment (BA) frame is set to:

2*BA+n*(data block length)+(1+n)*SIFS,

where n*(data block length) represents transmission duration required for retransmitting n data blocks that fail to be received in the continuous data frame, herein, n represents the number of retransmitted data blocks; 2*BA represents transmission duration of the first BA frame, and transmission duration of a second BA frame corresponding to the retransmitted n data blocks; 2*SIFS represents short interframe spaces between the retransmitted n data blocks and the first BA frame, and between the retransmitted n data blocks and the second BA frame.

A specific example is provided below according to above-mentioned embodiments.

The data transmission method provided by the example of the present disclosure includes: a data frame receiver sends an acknowledgment (ACK) frame to a data frame sender, if a data frame is not correctly received, a duration field in a returned ACK frame is set to: 2*ACK transmission duration+2*SIFS+data frame transmission duration, where 2*ACK transmission duration includes transmission duration of the ACK frame itself, and transmission duration of an ACK frame of the retransmitted data frame; the data frame transmission duration represents transmission duration of the retransmitted data frame; SIFS represents a short interframe space.

A duration field in an MAC frame header of the ACK/BA frame is set as follows:

for a unicast data frame:

the data frame receiver feeds back an ACK frame; if the data frame is not correctly received, the duration field in the ACK frame is set to: 2*ACK transmission duration+data frame length transmission duration+2*SIFS;

for a continuous data frame:

when a block acknowledgment frame is fed back, and when some data frames in the continuous data frame are not successfully received, a duration field in the block acknowledgment frame fed back is set to: 2*BA+n*(data frame length)+(1+n)*SIFS, where n represents number of data frames that need to be retransmitted.

A value of n equals to the number of bits set to “0” in the bitmap in BA.

NAV settings for other STAs

After receiving the ACK frame, other STAs set their own NAVs according to the duration field in the ACK frame. If duration indicated by the duration field in the ACK/BA frame is less than current duration set by the NAV, the NAV is kept unchanged. If duration indicated by the duration field in the ACK/BA frame is greater than the current duration set by the NAV, the current duration of the NAV is updated with the duration indicated by the duration field.

Identification of ACK/Block ACK

A new ACK frame format is identified using a type and a subtype fields in the MAC frame header of the ACK/Block ACK frame, indicating that there is a retransmitted data frame after the ACK/Block ACK frame is sent.

Embodiments of the present disclosure further provide a data transmission apparatus, which is applied to a first communication device for wireless communication. As shown in FIG. 4, the data transmission apparatus 100 includes a first determination module 110 and a sending module 120.

The first determination module 110 is configured to determine duration indication information according to reception of a data frame in multi-transport connection transmission, wherein the duration indication information is used to indicate duration of the transport connection continuing to be occupied.

The sending module 120 is configured to send a first acknowledgement message frame, wherein the first acknowledgement message frame includes feedback information about the reception and the duration indication information.

In some embodiments, the first determination module 110 includes a first determination submodule 111.

The first determination submodule 111 is configured to determine the duration indication information when the data frame fails to be received, wherein the duration indicated by the duration indication information comprises transmission duration of a retransmitted data frame.

In some embodiments, the duration indicated by the duration indication information further includes at least one of the following:

transmission duration of the first acknowledgement message frame; and

transmission duration of a second acknowledgement message frame corresponding to the retransmitted data frame.

In some embodiments, when the data frame is a unicast data frame, the transmission duration of the retransmitted data frame comprises transmission duration for retransmitting the unicast data frame.

In some embodiments, when the data frame is a continuous data frame, the first acknowledgement message frame is a block acknowledgement message frame.

The transmission duration of the retransmitted data frame comprises transmission duration for retransmitting n data blocks failing to be received in the continuous data frame.

In some embodiments, the duration indicated by the duration indication information further includes a short interframe space between two adjacent data blocks among the data blocks.

In some embodiments, the duration indicated by the duration indication information further includes at least one of: a short interframe space between the first acknowledgement message frame and the retransmitted data frame; and a short interframe space between the retransmitted data frame and a second acknowledgement message frame corresponding to the retransmitted data frame.

In some embodiments, the first determination module 110 includes a second determination submodule 112.

The second determination submodule 112 is configured to determine the duration indication information when the data frame fails to be received, and an expression of the duration indicated by the duration indication information includes:

2*ACK+data frame length+2*SIFS,

where 2*ACK represents transmission duration of the first acknowledgement message frame, and transmission duration of a second acknowledgement message frame corresponding to the retransmitted data frame; the data frame length represents transmission duration for retransmitting a unicast data frame, wherein the data frame is the unicast data frame; 2*SIFS represents two short interframe spaces.

In some embodiments, the first determination module 110 includes a third determination submodule 113.

The third determination submodule 113 is configured to determine the duration indication information when the data frame fails to be received, and an expression of the duration indicated by the duration indication information includes:

2*BA+n*(data block length)+(1+n)*SIFS,

where 2*BA represents transmission duration of the first acknowledgement message frame, and transmission duration of a second acknowledgement message frame corresponding to the retransmitted data frame; the n*(data block length) represents transmission duration for retransmitting n data blocks failing to be received in a continuous data frame, wherein the data frame is the continuous data frame; (1+n)*SIFS represents (n+1) short interframe spaces.

In some embodiments, the duration indication information includes:

a duration field in a Media Access Control (MAC) frame header of the first acknowledgement message frame,

and

a length field in a physical frame header of the first acknowledgment message frame.

In some embodiments, the first determination module 110 includes a fourth determination submodule 114.

The fourth determination submodule 114 is configured to determine the duration indicated by the duration indication information as 0 when the data frame is successfully received.

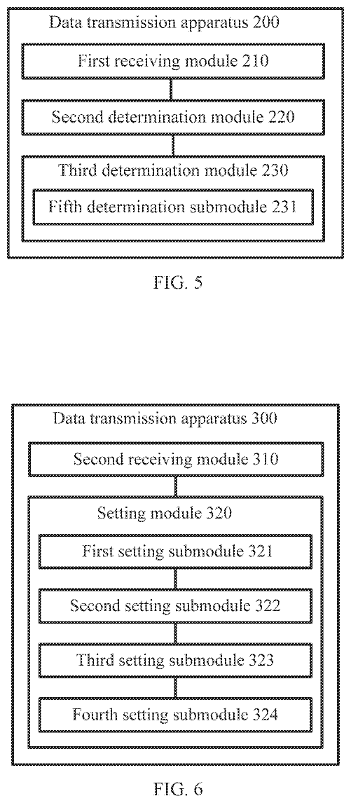

Embodiments of the present disclosure further provide a data transmission apparatus, which is applied to a second communication device for wireless communication. As shown in FIG. 5, the data transmission apparatus 200 includes a first receiving module 210, a second determination module 220 and a third determination module 230.

The first receiving module 210 is configured to receive a first acknowledgement message frame.

The second determination module 220 is configured to determine reception of a data frame in multi-transport connection transmission according to feedback information in the first acknowledgment message frame.

The third determination module 230 is configured to determine duration of the transport connection continuing to be occupied according to duration indication information in the first acknowledgment message frame, wherein the duration indication information is based on the reception of the data frame.

In some embodiments, when the data frame fails to be received, the duration indicated by the duration indication information comprises transmission duration of a retransmitted data frame.

In some embodiments, the duration indicated by the duration indication information further includes at least one of the following:

transmission duration of the first acknowledgement message frame; and

transmission duration of a second acknowledgement message frame corresponding to the retransmitted data frame.

In some embodiments, when the data frame is a unicast data frame, the transmission duration of the retransmitted data frame comprises transmission duration for retransmitting the unicast data frame.

In some embodiments, when the data frame is a continuous data frame, the first acknowledgement message frame is a block acknowledgement message frame.

The transmission duration of the retransmitted data frame includes transmission duration for retransmitting n data blocks failing to be received in the continuous data frame.

In some embodiment, the duration indicated by the duration indication information further includes a short interframe space between two adjacent data blocks among the data blocks.

In some embodiments, the duration indicated by the duration indication information further includes: a short interframe space between the first acknowledgement message frame and the retransmitted data frame; and a short interframe space between the retransmitted data frame and a second acknowledgement message frame corresponding to the retransmitted data frame.

In some embodiments, when the data frame fails to be received, an expression of the duration indicated by the duration indication information includes:

2*ACK+data frame length+2*SIFS

where 2*ACK represents transmission duration of the first acknowledgement message frame, and transmission duration of a second acknowledgement message frame corresponding to the retransmitted data frame; the data frame length represents transmission duration for retransmitting a unicast data frame, wherein the data frame is the unicast data frame; 2*SIFS represents two short interframe spaces.

In some embodiments, when the data frame fails to be received, an expression of the duration indicated by the duration indication information includes:

2*BA+n*(data block length)+(1+n)*SIFS,

where 2*BA represents transmission duration of the first acknowledgement message frame, and transmission duration of a second acknowledgement message frame corresponding to the retransmitted data frame; the n*(data block length) represents transmission duration for retransmitting n data blocks failing to be received in a continuous data frame, wherein the data frame is the continuous data frame; (1+n)*SIFS represents (n+1) short interframe spaces.

In some embodiments, the third determination module 230 includes a fifth determination submodule 231.

The fifth determination submodule 231 is configured to determine the duration of the transport connection continuing to be occupied according to indication of a duration field in a Media Access Control (MAC) frame header of the first acknowledgement message frame.

Embodiments of the present disclosure further provide a data transmission apparatus, which is applied to a third communication device for wireless communication. As shown in FIG. 6, the data transmission apparatus 300 includes a second receiving module 310 and a setting module 320.

The second receiving module 310 is configured to receive a first acknowledgement message frame.

The setting module 320 is configured to set a Network Allocation Vector (NAV) according to duration of a transport connection continuing to be occupied indicated by duration indication information in the first acknowledgment message frame, wherein the duration indication information is based on reception of a data frame in multi-transport connection transmission.

In some embodiments, when the data frame fails to be received, the duration indicated by the duration indication information includes transmission duration of a retransmitted data frame.

In some embodiments, the duration indicated by the duration indication information further includes at least one of the following:

transmission duration of the first acknowledgement message frame; and

transmission duration of a second acknowledgement message frame corresponding to the retransmitted data frame.

In some embodiments, when the data frame is a unicast data frame, the transmission duration of the retransmitted data frame includes transmission duration for retransmitting the unicast data frame.

In some embodiments, when the data frame is a continuous data frame, the first acknowledgement message frame is a block acknowledgement message frame.

The transmission duration of the retransmitted data frame includes transmission duration for retransmitting n data blocks failing to be received in the continuous data frame.

In some embodiments, the duration indicated by the duration indication information further includes a short interframe space between two adjacent data blocks among the data blocks.

In some embodiments, the duration indicated by the duration indication information further includes: a short interframe space between the first acknowledgement message frame and the retransmitted data frame; and a short interframe space between the retransmitted data frame and a second acknowledgement message frame corresponding to the retransmitted data frame.

In some embodiments, when the data frame fails to be received, an expression of the duration indicated by the duration indication information includes:

2*ACK+data frame length+2*SIFS,

where 2*ACK represents transmission duration of the first acknowledgement message frame, and transmission duration of a second acknowledgement message frame corresponding to the retransmitted data frame; the data frame length represents transmission duration for retransmitting a unicast data frame, wherein the data frame is the unicast data frame; 2*SIFS represents two short interframe spaces.

In some embodiments, when the data frame fails to be received, an expression of the duration indicated by the duration indication information includes:

2*BA+n*(data block length)+(1+n)*SIFS,

where 2*BA represents transmission duration of the first acknowledgement message frame, and transmission duration of a second acknowledgement message frame corresponding to the retransmitted data frame; the n*(data block length) represents transmission duration for retransmitting n data blocks failing to be received in a continuous data frame, wherein the data frame is the continuous data frame; (1+n)*SIFS represents (n+1) short interframe spaces.

In some embodiments, the setting module 320 includes:

a first setting submodule 321 configured to set the NAV according to the duration of the transport connection continuing to be occupied indicated by a duration field in a Media Access Control (MAC) frame header of the first acknowledgement message frame;

or

a second setting submodule 322 configured to set the NAV according to the duration of the transport connection continuing to be occupied indicated by a length field in a physical frame header of the first acknowledgment message frame.

In some embodiments, the setting module 320 includes a third setting submodule 323.

The third setting submodule 323 is configured to update, in response to the duration being greater than backoff duration indicated by the NAV, the backoff duration using the duration, wherein the backoff duration is a duration to keep silent on the transport connection.

In some embodiments, the setting module 320 includes a fourth setting submodule 324.

The fourth setting submodule 324 is configured to maintain the NAV in response to the duration being less than or equal to backoff duration indicated by the NAV, wherein the backoff duration is a duration to keep silent on the transport connection.

In some exemplary embodiments, the first determination module 110, the sending module 120, the first receiving module 210, the second determination module 220, the third determination module 230, the second receiving module 310, the setting module 320, etc., may be realized by one or more of Central Processing Units (CPUs), Graphics Processing Units (GPUs), Baseband Processors (BPs), Application Specific Integrated Circuits (ASICs), DSPs, Programmable Logic Devices (PLDs), Complex Programmable Logic Devices (CPLDs), Field Programmable Gate Arrays (FPGAs), general purpose processors, controllers, Micro Controller Units (MCUs), microprocessors, or other electronic components to implement above methods.

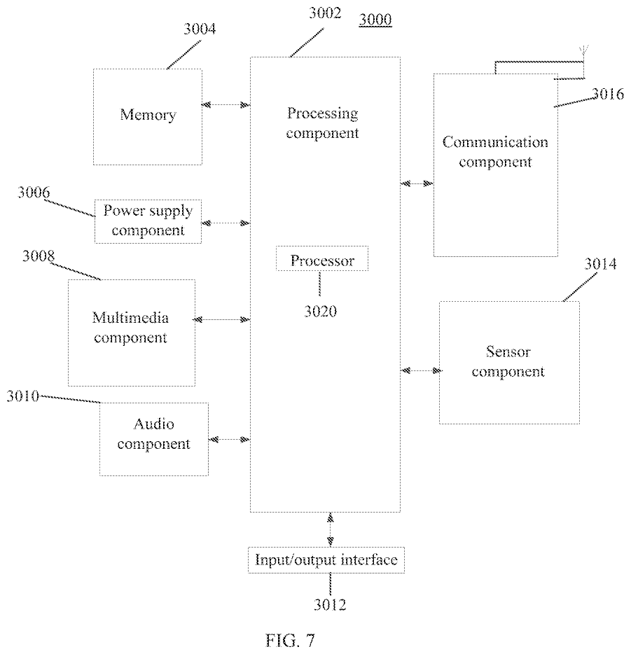

FIG. 7 is a block diagram of an apparatus 3000 for data transmission according to an exemplary embodiment. For example, the apparatus 3000 may be a mobile phone, a computer, a digital broadcast terminal, a messaging device, a game console, a tablet device, a medical device, a fitness device, a personal digital assistant, etc.

As shown in FIG. 7, the apparatus 3000 may include one or more of the following components: a processing component 3002, a memory 3004, a power supply component 3006, a multimedia component 3008, an audio component 3010, an input/output (I/O) interface 3012, a sensor component 3014, and a communication component 3016.

The processing component 3002 generally controls overall operations of the apparatus 3000, such as operations associated with display, phone calls, data communications, cameras, and recording. The processing component 3002 may include one or more processors 720 to execute instructions to implement all or part of the steps of the method on the first terminal side or the method on the second terminal side described above. Additionally, the processing component 3002 may include one or more modules to facilitate interactions between the processing component 3002 and other components. For example, the processing component 3002 may include a multimedia module to facilitate an interaction between the multimedia component 3008 and the processing component 3002.

Memory 3004 is configured to store various types of data to support operations in the apparatus 3000. Examples of such data include instructions, contact data, phonebook data, messages, pictures, videos, and the like, used for any application or method running or implemented on the apparatus 3000. Memory 3004 may be implemented by any type of volatile or nonvolatile storage device or combination thereof, such as static random access memory (SRAM), electrically erasable programmable read only memory (EEPROM), erasable programmable read only memory (EPROM), programmable read only memory (PROM), read only memory (ROM), magnetic memory, flash memory, magnetic disk or optical disk.

The power supply component 3006 provides power to various components of the apparatus 3000. The power supply component 3006 may include a power management system, one or more power supplies, and other components associated with generating, managing, and distributing power to the apparatus 3000.

The multimedia component 3008 includes a screen that provides an output interface between the apparatus 3000 and a user. In some embodiments, the screen may include a liquid crystal display (LCD) and a touch panel (TP). In a case where the screen includes a touch panel, the screen may be implemented as a touch screen to receive input signals from the user. The touch panel includes one or more touch sensors to sense touch, swipe, and other gestures on the touch panel. The touch sensor may not only sense boundaries of a touch or a swipe action, but also detect duration and pressure associated with the touch or swipe action. In some embodiments, the multimedia component 3008 includes a front camera and/or a rear camera. When the apparatus 3000 is in an operation mode, such as a shooting mode or a video mode, the front camera and/or the rear camera may receive external multimedia data. Each of the front and rear cameras can be a fixed optical lens system or have focal length and optical zoom capability.

The audio component 710 is configured to output and/or input audio signals. For example, the audio component 710 includes a microphone (MIC) that is configured to receive external audio signals w % ben the apparatus 3000 is in an operating mode, such as a call mode, a recording mode, and a voice recognition mode. The received audio signal may be further stored in memory 3004 or transmitted via the communication component 716. In some embodiments, the audio component 710 further includes a speaker for outputting audio signals.

I/O interface 712 provides an interface between the processing component 3002 and peripheral interface modules, and the peripheral interface modules may be keyboards, click wheels, buttons, and the like. These buttons may include, but are not limited to a home button, a volume button, a start button, and a lock button.

The sensor component 714 includes one or more sensors for providing state assessment of various aspects of the apparatus 3000. For example, the sensor component 714 can detect an open/closed state of the apparatus 3000, relative positioning of the component, such as the display and the keypad of the apparatus 3000. The sensor component 714 can also detect changes in a position of the apparatus 3000 or one component of the electronic devices 3000, presence or absence of contact with the apparatus 3000, orientation or acceleration/deceleration of the apparatus 3000 and changes in temperature of the apparatus 3000. The sensor component 714 may include a proximity sensor configured to detect the presence of nearby objects when there is no physical contact. The sensor component 714 may also include a light sensor, such as a CMOS or a CCD image sensor, for use in imaging applications. In some embodiments, the sensor component 714 may also include an acceleration sensor, a gyroscope sensor, a magnetic sensor, a pressure sensor, or a temperature sensor.

The communication component 716 is configured to facilitate wired or wireless communications between the apparatus 3000 and other devices. The apparatus 3000 may access to a wireless network based on a communication standard, such as Wi-Fi, a carrier network (e.g., 2G, 3G, 4G, or 5G), or a combination thereof. In some embodiments, the communication component 716 receives broadcast signals or broadcast related information from an external broadcast management system via a broadcast channel. In some embodiments, the communication component 716 further includes a near field communication (NFC) module to facilitate short-range communication. For example, the NFC module may be implemented based on radio frequency identification (RFID) technology, infrared data association (IrDA) technology, ultra-wideband (UWB) technology, Bluetooth (BT) technology and other technologies.

In some embodiments, the apparatus 3000 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors or other electronic components, for implementing the method on the first terminal side, or the method on the second terminal side mentioned above.

In some exemplary embodiments, a non-transitory computer-readable storage medium including instructions, such as a memory 3004 including instructions, is also provided, and the instructions can be executed by the processor 3020 of the apparatus 3000 to implement above method. For example, the non-transitory computer-readable storage medium may be ROM, random access memory (RAM), CD-ROM, magnetic tape, floppy disk, and optical data storage devices, etc.

Other embodiments of the present disclosure will readily occur to those skilled in the art upon consideration of the specification and practice of embodiments disclosed herein. The present disclosure is intended to cover any variations, uses, or adaptations of the disclosure that follow the general principles of the present disclosure and include common general knowledge or techniques in the technical field not disclosed by the disclosure. The specification and examples are to be regarded as exemplary only, with the true scope and spirit of the disclosure being indicated by the appended claims.

It should be understood that the present disclosure is not limited to the precise structures described above and illustrated in the accompanying drawings, and that various modifications and changes may be made without departing from the scope thereof. The scope of the present disclosure is limited only by the appended claims.

1. A data transmission method, applied to a communication device, comprising:
determining duration indication information according to reception of a data frame in multi-transport connection transmission, wherein the duration indication information is configured to indicate duration of a transport connection continuing to be occupied; and
sending a first acknowledgement message frame, wherein the first acknowledgement message frame comprises feedback information about the reception and the duration indication information.

2. The method according to claim 1, wherein determining the duration indication information according to the reception of the data frame in multi-transport connection transmission comprises:
determining the duration indication information in response to failed reception of the data frame, wherein the duration indicated by the duration indication information comprises transmission duration of a retransmitted data frame.

3. The method according to claim 2, wherein the duration indicated by the duration indication information further comprises at least one of:
transmission duration of the first acknowledgement message frame; and
transmission duration of a second acknowledgement message frame corresponding to the retransmitted data frame.

4. The method according to claim 2, wherein the data frame is a unicast data frame, and the transmission duration of the retransmitted data frame comprises transmission duration for retransmitting the unicast data frame.

5. The method according to claim 2, wherein the data frame is a continuous data frame, the first acknowledgement message frame is a block acknowledgement message frame and the transmission duration of the retransmitted data frame comprises transmission duration for retransmitting n data blocks failing to be received in the continuous data frame, wherein n is a positive integer greater than or equal to 1, and less than or equal to a number of data blocks contained in the continuous data frame.

6. The method according to claim 5, wherein the duration indicated by the duration indication information further comprises a short interframe space between two adjacent data blocks among the data blocks.

7. The method according to claim 2, wherein the duration indicated by the duration indication information further comprises at least one of:
a short interframe space between the first acknowledgement message frame and the retransmitted data frame; and
a short interframe space between the retransmitted data frame and a second acknowledgement message frame corresponding to the retransmitted data frame.

8. The method according to claim 2, wherein
the data frame is a unicast data frame, and determining the duration indication information according to the reception of the data frame in multi-transport connection transmission comprises:
determining the duration indication information in response to failed reception of the data frame, wherein an expression of the duration indicated by the duration indication information comprises:
2*ACK+data frame length+2*SIFS,
where 2*ACK represents transmission duration of the first acknowledgement message frame, and transmission duration of a second acknowledgement message frame corresponding to the retransmitted data frame; the data frame length represents transmission duration for retransmitting the unicast data frame; 2*SIFS represents two short interframe spaces.

9. The method according to claim 2, wherein
the data frame is a continuous data frame, and determining the duration indication information according to the reception of the data frame in multi-transport connection transmission comprises:
determining the duration indication information in response to failed reception of the data frame fails, wherein an expression of the duration indicated by the duration indication information comprises:
2*BA+n*(data block length)+(1+n)*SIFS,
where 2*BA represents transmission duration of the first acknowledgement message frame, and transmission duration of a second acknowledgement message frame corresponding to the retransmitted data frame; the n*(data block length) represents transmission duration for retransmitting n data blocks failing to be received in the continuous data frame, wherein n is a positive integer greater than or equal to 1, and less than or equal to a number of data blocks contained in the continuous data frame; (1+n)*SIFS represents (n+1) short interframe spaces.

10. The method according to claim 1, wherein the duration indication information comprises a duration field in a Media Access Control (MAC) frame header of the first acknowledgement message frame, and a length field in a physical frame header of the first acknowledgment message frame.

11. The method according to claim 1, wherein determining duration indication information according to reception of a data frame in multi-transport connection transmission comprises determining the duration indicated by the duration indication information as 0 in response to successful reception of the data frame.

12. A data transmission method, applied to a communication device, comprising:
receiving a first acknowledgement message frame;
determining reception of a data frame in multi-transport connection transmission according to feedback information in the first acknowledgment message frame; and
determining duration of a transport connection continuing to be occupied according to duration indication information in the first acknowledgment message frame, wherein the duration indication information is based on the reception of the data frame.

13. The method according to claim 12, wherein in response to failed reception of the data frame, the duration indicated by the duration indication information comprises transmission duration of a retransmitted data frame.

14. The method according to claim 13, wherein the duration indicated by the duration indication information further comprises at least one of:
transmission duration of the first acknowledgement message frame; and
transmission duration of a second acknowledgement message frame corresponding to the retransmitted data frame.

15. The method according to claim 13, wherein the data frame is a unicast data frame, and the transmission duration of the retransmitted data frame comprises transmission duration for retransmitting the unicast data frame.

16. The method according to claim 13, wherein the data frame is a continuous data frame, the first acknowledgement message frame is a block acknowledgement message frame and the transmission duration of the retransmitted data frame comprises transmission duration for retransmitting n data blocks failing to be received in the continuous data frame.

17-21. (canceled)

22. A data transmission method, applied to a third communication device, comprising:
receiving a first acknowledgement message frame; and
setting a Network Allocation Vector (NAV) according to duration of a transport connection continuing to be occupied indicated by duration indication information in the first acknowledgment message frame, wherein the duration indication information is based on reception of a data frame in multi-transport connection transmission.

23-30. (canceled)

31. The method according to claim 22, wherein setting the NAV comprises at least one of:
setting the NAV according to the duration of the transport connection continuing to be occupied indicated by a duration field in a Media Access Control (MAC) frame header of the first acknowledgement message frame; or
setting the NAV according to the duration of the transport connection continuing to be occupied indicated by a length field in a physical frame header of the first acknowledgment message frame.

32. The method according to claim 22, wherein setting the NAV a comprises:
updating, in response to the duration being greater than backoff duration indicated by the NAV, the backoff duration using the duration, wherein the backoff duration is a duration to keep silent on the transport connection.

33. The method according to claim 22, wherein setting the NAV a comprises:
maintaining the NAV in response to the duration being less than or equal to backoff duration indicated by the NAV, wherein the backoff duration is a duration to keep silent on the transport connection.

34-68. (canceled)
